(19) United States
(12) Patent Application Publication
(10) Pub. No.: US 2013/0095333 A1
(43) Pub. Date: Apr. 18, 2013

(54) Surface Treated Medium

(71) Applicants: Lokendra Pal, San Diego, CA (US); Xulong Fu, San Diego, CA (US); Xiaoqi Zhou, San Diego, CA (US); Ronald J. Selensky, Poway, CA (US)

(72) Inventors: Lokendra Pal, San Diego, CA (US); Xulong Fu, San Diego, CA (US); Xiaoqi Zhou, San Diego, CA (US); Ronald J. Selensky, Poway, CA (US)

(21) Appl. No.: 13/273,895

(22) Filed: Oct. 14, 2011

(51) Int. Cl. B32B 27/20; B05D 1/28; B05D 1/18; C09D 129/04; B05D 3/12; B05D 3/04; C08K 5/544; B05D 1/02; B05D 1/30

(52) U.S. Cl. 428/447; 427/369; 427/427.4; 427/256; 427/428.11; 427/430.1; 427/420; 427/358; 427/355; 427/348; 524/188

(57) ABSTRACT

A method of forming a surface treated medium in which a surface treatment solution is formed comprising a number of water soluble, multi-valent salts, a number of water dispersible, multi-valent salts, a binder that binds the water dispersible, multi-valent salts to a medium and to the elements within the surface treatment solution, and an organosilane, and the surface treatment solution is applied to a medium. A surface treatment solution comprises a number of water soluble, multi-valent, organic acid salts, a number of water dispersible, multi-valent, organic acid salts, a binder that binds the water dispersible, multi-valent, organic acid salts to a medium and to the elements within the surface treatment solution, and an organosilane.

### BACKGROUND

Surface treatments are used in the production of print media to improve image quality and reduce the drying times after printing. Surface treatment solution may contain soluble multivalent salts such as CaCl₂. Surface treatment provides the medium with special functionality which can separate pigmented ink colorants from the ink vehicles and chemically or physically bind the anionically charged ink colorants on the outermost surface of the ink receiving media. Surface treatment provides additional protection from environmental elements such as water, and improves the abrasiveness, creasibility, finish, printability, smoothness, and surface bond strength, while decreasing surface porosity and fuzzing. For example, the surface treatment protects the medium by ensuring that water does not absorb into the medium and displace or otherwise remove or distort the ink printed on the medium.

### BRIEF DESCRIPTION OF THE DRAWINGS

The accompanying drawings illustrate various examples of the principles described herein and are a part of the specification. The illustrated examples are given merely for illustration, and do not limit the scope of the claims.

FIG. 1 is a cross-sectional diagram of a surface treated print media, according to one example of the principles described herein.

FIG. 2 is a cross-sectional diagram of a surface treated print media, according to another example of the principles described herein.

FIG. 3 is a bar chart depicting the black color optical density (KoD) of the example formulations of surface treatment solutions of Table 1, according to one example of the principles described herein.

Throughout the drawings, identical reference numbers designate similar, but not necessarily identical, elements.

### DETAILED DESCRIPTION

One drawback of applying surface treatments containing inorganic metallic salts to print media is the corrosion concerns caused by inorganic anions such as, for example, chloride Cl¹⁻ within the surface treatment solutions. These inorganic ions are corrosive to many metal objects. These water soluble salts are electrolytic, and inevitably initialize corrosion reactions when brought into contact with the metal surfaces of various machines used to produce the print media as well as metal surfaces of printing devices.

The present disclosure describes a surface treatment solution, associated print media comprising the surface treatment solution, and methods of forming the print media comprising the surface treatment solution. In one example, the surface treatment solution comprises a number of water soluble, multi-valent salts, a number of water dispersible, multi-valent salts, a binder that binds the water dispersible, multi-valent salts to a medium and to the elements within the surface treatment solution, and an organosilane. Print media treated with a mixture of soluble and dispersible organic salt will produce improved image quality while significantly reducing or eliminating soluble multivalent inorganic salts such as CaCl₂.

As used in the present specification and in the appended claims, the term “medium,” “media,” “print medium,” or similar language is meant to be understood broadly as any medium upon which ink may be applied. In one example, the medium is made from cellulosic fibers. In another example, the medium is made from synthetic fibers such as, for example, polyamides, polyesters, polyethylene, and polyacrylic fibers. In yet another example, the medium is made from inorganic fibers such as, for example, asbestos, ceramic, and glass fibers. In still another example, the medium may be made of a combination of the above materials. The medium may be formed in any dimension, size, or thickness. Further, the medium may be of any form such as, for example, pulp, wet paper, or dry paper. Further, the medium may comprise a mixture of fibers, for example, wood fibers, non-wood fibers, and recycled fibers. Medium is meant to encompass printing paper such as, for example, inkjet printing paper, and may further include other forms of paper such as, for example, writing paper, drawing paper, and photobase paper, as well as board materials such as, for example, cardboard, poster board, and Bristol board.

The fibers may be produced from chemical pulp, mechanical pulp, thermal mechanical pulp, chemical mechanical pulp, and chemi-thermo-mechanical pulp (CTMP), for example. Examples of wood pulps include, but are not limited to, kraft pulps and sulfite pulps, each of which may or may not be bleached. Examples of softwoods include, but are not limited to, pines, spruces, and hemlocks. Examples of hardwoods include, but are not limited to, birch, maple, oak, poplar and aspen.

The paper medium may further comprise internal starch, inorganic fillers, internal sizing agents, and other additives that provide functional and operational benefits. These additives also may be added to the fiber mixture or pulp stock before it is converted to the paper web. Examples of starch include, but are not limited to, Apollo® cationic corn starch, Astro X® cationic potato starch, Pencat® cationic corn starch, and Topcat® cationic additive all available from Penford Products Co., Cedar Rapids, Iowa, U.S.A.

Examples of fillers that may be incorporated into the fiber mixture of the paper medium include, but are not limited to, carbonates, ground calcium carbonate (GCC), precipitated calcium carbonate (PCC), titanium dioxide, clays, talc, and combinations of the above. Examples of filler include, but are not limited to, Magfil® PCC from Specialty Minerals, Inc. of Bethlehem, Pa., U.S.A., or Omyafil® GCC from Omya North America.

Examples of internal sizing agents include, but are not limited to, fatty acids, alkyl ketene dimer (AKD) emulsification products, alkenyl acid anhydride emulsification products, alkylsuccinic acid anhydride (ASA) emulsification products, and rosin derivatives. Some examples of commercially available ASA and AKD include, but are not limited to, Nalco® 7542 ASA from Nalco Company, Ill., U.S.A., Basoplast® 2030 AKD from BASF, and Hercon® 195 AKD from Hercules Inc. USA.

Examples of retention/drainage aids include, but are not limited to, a polyacrylamide, polyaluminum chloride, microparticles, cationic starch, a flocculant, and a dispersant. In some examples, the paper medium may further comprise an optical brightening agent (OBA) to control the brightness. Some examples of commercially available OBAs may include, but are not limited to, Tinopal® ABP-A from Ciba Specialty Chemicals, High Point, N.C. USA., and Leucophor SAC, SPS, STR, SHR, S liq from Clariant Company, Charleston, N.C., USA. Some examples of commercially available dyes may include, but are not limited to, Irgalite® Violet BL & Irgalite® Blue R-L from Ciba Specialty Chemicals, High Point, N.C. Other agents and additives including, but not limited to, dyes, de-foaming agents, biocides, buffering agents and pitch control agents may be included in the fiber mixture of the paper medium in some examples.

Further, as used in the present specification and in the appended claims, the term “surface treatment” or “surface treatment solution” is meant to be understood broadly as any substance applied to or incorporated into an outermost surface of a medium upon which ink may interact. In one example, surface treatment provides the medium with special functionality which can separate pigmented ink colorants from the ink vehicles and chemically or physically bind the anionically charged ink colorants on the outermost surface of the ink receiving media. In yet another example, the surface treatment provides additional protection from environmental elements such as water, and improves the abrasiveness, creasibility, finish, printability, smoothness, and surface bond strength, while decreasing surface porosity and fuzzing. For example, the surface treatment protects the medium by ensuring that water does not absorb into the medium and displace or otherwise remove or distort the ink printed on the medium.

Further, as used in the present specification and in the appended claims, the term “weight percent” or “wt %” is meant to be understood broadly as the mass fraction (wᵢ) of one substance with mass mᵢ to the mass of the total mixture mₜₒₜ, multiplied by 100. The mass fraction (wᵢ) is defined by the following equation:

$${w}_{i} = \frac{{m}_{i}}{{m}_{tot}} \qquad Eq . 1$$

and weight percent is defined by the following equation:

wt %=wᵢ*100 Eq. 2

Further, as used in the present specification and in the appended claims, the term “black color optical density” or “KoD” is meant to be understood broadly as the defined as:

$${A}_{λ} = {log}_{10} ( \frac{{I}_{0}}{I} )$$

where I is the intensity of light at a specified wavelength λ that has passes through a sample (transmitted light intensity) and I₀ is the intensity of the light before it enters the sample or incident light intensity.

Even still further, as used in the present specification and in the appended claims, the term “a number of” or similar language is meant to be understood broadly as any positive number comprising 1 to infinity; zero not being a number, but the absence of a number.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

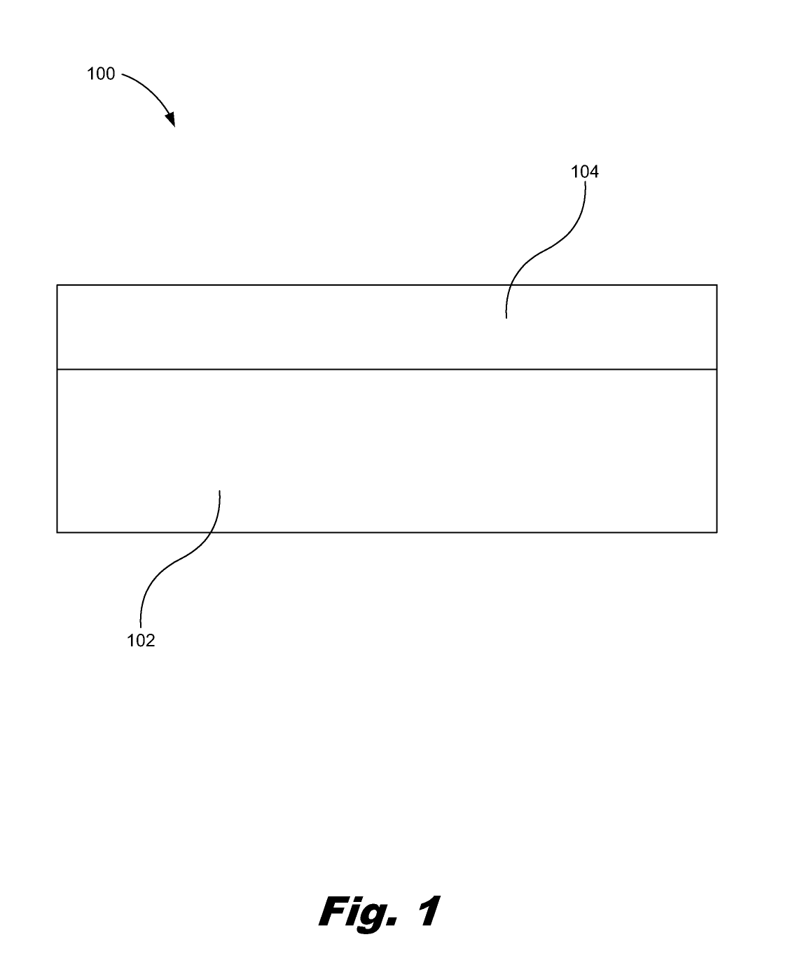

FIG. 1 is a cross-sectional diagram of a surface treated print media (100), according to one example of the principles described herein. In the example of FIG. 1, a surface treatment solution (104) is applied to a print medium (102). In this example, the surface treatment solution (104) is covered over the surface of the print medium (102), and forms a film with an ability to fix print ink on the paper surface to produce a sharp image, high KoD, and controlled ink penetration. In the example of FIG. 1, the surface treatment solution (104) is applied to the surface of the print medium (102) by, for example, puddle size press, metered size press, spray coating, gravure coating, reverse roll coating, gap coating, slot die coating, immersion coating, curtain coating, blade coating, rod coating, air knife coating, or combinations thereof. In one example, the surface treatment solution is applied to the print medium (102) at a coat weight of between approximately 0.2 and 6 gsm.

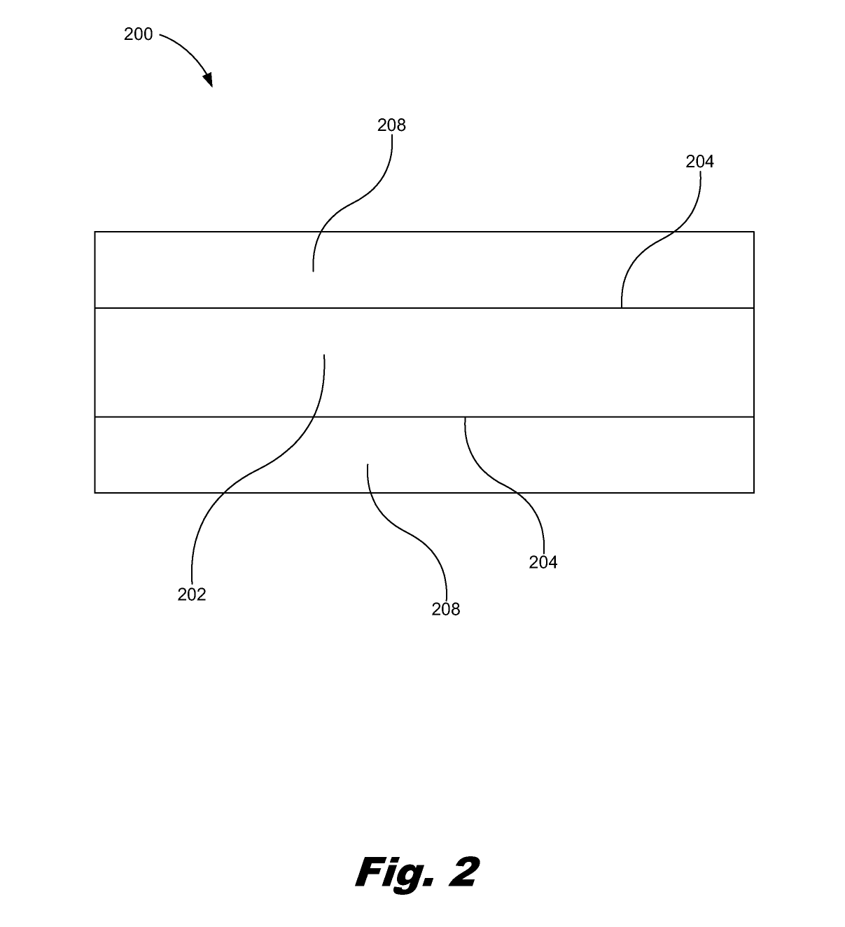

FIG. 2 is a cross-sectional diagram of a surface treated print media (200), according to another example of the principles described herein. In the example of FIG. 2, a surface treatment solution (208) is applied to a first side (204) and a second side (206) of a print medium (202) either on-line in a dry web stage of paper manufacture processing, or off-line as a separate coating processing on an off-line coater. In one example, the surface treatment solution is applied to the print medium (202) at a coat weight of between approximately 0.2 and 6 gsm.

In one example, the surface treatment solution comprises an organic water soluble metallic salt and an organic water dispersible metallic salt. Organic metallic salt are ionic compounds composed of cations and anions with a formula such as (CₙH₂ₙ₊₁COO⁻M⁺)*(H₂O)ₘ where M⁺ is cation species including Group I metals, Group II metals, Group III metals and transition metals such as, for example, sodium, potassium, calcium, copper, nickel, zinc, magnesium, barium, iron, aluminum and chromium ions. Anion species can include any negatively charged carbon species with a value of n from 1 to 35. The hydrates (H₂O) are water molecules attached to salt molecules with a value of m from 0 to 20.

Water soluble is meant to be understood broadly as a species that is readily dissolved in water. Thus, water soluble salts may refer to a salt that has a solubility greater than 15 g/100 g H₂O at 1 atm pressure and 20° C. Examples of water soluble salt include, but are not limited to, calcium acetate, calcium acetate hydrate, calcium acetate monohydrate, magnesium acetate, magnesium acetate tetrahydrate, calcium propionate, calcium propionate hydrate, calcium gluconate monohydrate, and calcium formate.

Water dispersible is meant to be understood broadly as a species that does not readily dissolve in water. Thus, water dispersible salts may have the same general chemical formulas as described above, but refer to a salt that has a water solubility less than 10 g/100 g H₂O at 1 atm pressure and 20° C. These particles exist in water in a solid state. However, water dispersible salts can be dispersed under various mixing conditions at low or high shear force, or with help of a chemical emulsifier to form a stable emulsion at a not extended time frame of processing, or media manufacture. Examples of water dispersible salts included, but are not limited to, calcium citrate, calcium citrate tetrahydrate, calcium oleate, and calcium oxalate.

In one example, the ratio of water soluble salts to water dispersible salts is from 9:1 to 1:1. In another example, the ratio of water soluble salts to water dispersible salts is from 4:1 to 1:1. When aqueous pigmented ink is jetted on the media (100, 200), cations from water soluble salts will de-stabilize the dispersed pigmented ink by separating the pigments from the ink vehicles. Water dispersible salts function as “fixers” to bond the ink colorant particles printed on the outermost surface of the surface treatment solution (104, 208) to the print media (100, 200). In this manner, the printing quality such as ink density and color gamut are significantly improved. Further, inorganic ions are corrosive to many metal objects, and, because they are electrolytic, inevitably initialize corrosion reactions when brought into contact with the metal surfaces of various machines used to produce the print media as well as metal surfaces of printing devices. Thus, another advantage in using water dispersible salts is the reduction or elimination of potential corrosion in machines used to produce and print on the print media.

In another example, the surface treatment solution compromises at least an organosilane with a general formula of (RO)₃SiR′ where R and R′ are any chemical group selected from alkyl groups, aromatic groups, and heteroaromatic groups. The RO groups are hydrolysable in a neutral to acidic environment. The function of organosilane is to modify the surface properties of the dispersible salt particles to make the dispersible salt particles more readily react with both the print medium (102, 202) and ink colorant particles. Examples of organosilanes include, but not limited to, mono amino silanes, diamino silanes, triamino silanes, bis(2-hydroethyl)-3-aminopropyltriethoxysilane, 3-mercaptopropyltrimethoxysilane, 3-glycidoxypropyltrimethoxysilane, bis(triethoxysilylpropyl)disulfide, 3-aminopropyltriethoxysilane, 3-aminopropylsilsesquioxane, bis-(trimethoxysilylpropyl)amine, N-phenyl-3-aminopropyltrimethoxysilane, N-aminoethyl-3-aminopropylmethyldimethoxysilane, 3-ureidopropyltrimethoxysilane, 3-methacryloxypropyltrimethoxysilane, N-(trimethyloxysilylpropyl)isothiouronium chloride, N-(triethoxysilpropyl)-O-polyethylene oxide, 3-(triethoxylsilyl)propylsuccinic anhydride, and 3-(2-imidazolin-1-yl)propyltriethoxysilane. Other useful organosilanes include, for example, 3-aminopropyltrimethoxysilane, N-(2-aminoethyl-3-aminopropyltrimethoxysilane, 3-(triethoxysilylpropyl)-diethylenetriamine, poly(ethyleneimine)trimethoxysilane, aminoethylaminopropyl trimethoxysilane, and aminoethylaminoethylaminopropyl trimethoxysilane. In one example, the ratio of dispersible salt to organosilane is from 1:2 to 10:1. In another example, the ratio of dispersible salt to organosilane is from 1:3 to 5:1.

Further, in another example, the surface treatment solution comprises a polymeric binder. The function of a binder is to provide the adhesion between dispersible salt particles and fillers (described below), and between the print medium (102, 202) and the dispersible salt and fillers. The binder may be any kind of natural or synthetic polymer. In one example, the polymers of the binder have neutral or cationic charges. Examples of binders include, but are not limited to, polyvinyl alcohol (PVOH), polyvinyl acetate (PVAc), polyacrylate latex, styrene butadiene latex, styrene acrylate latex, oxidized starch, cationic starch, ethylated starch, and chemically modified starches.

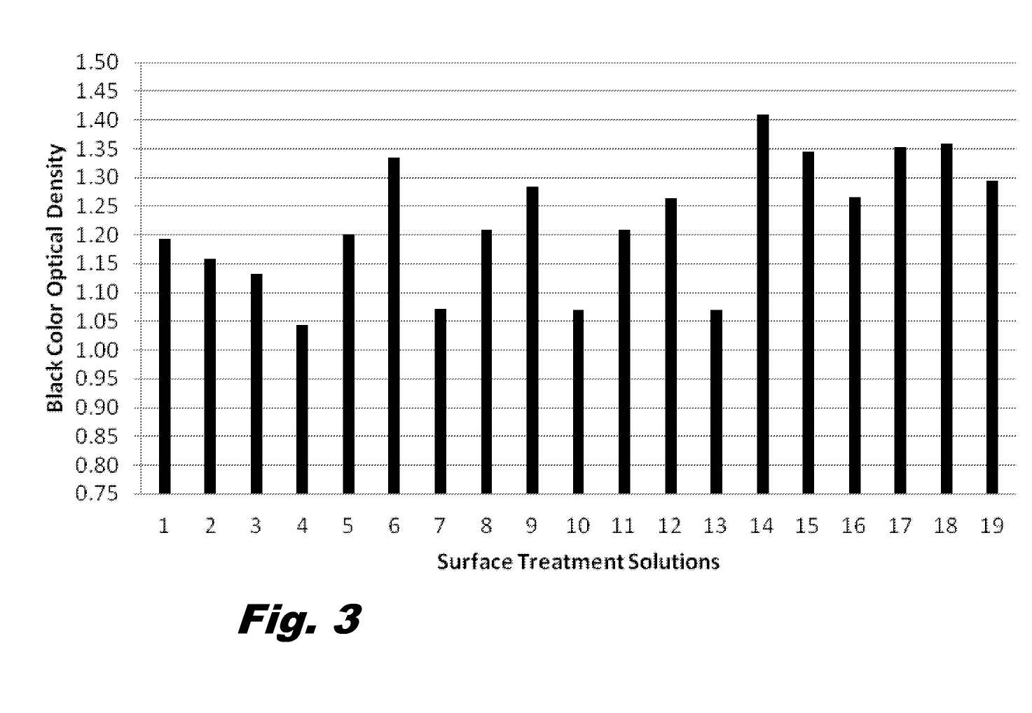

In the examples descried above, the surface treatment solution can include other chemical additives such as, for example, inorganic fillers, pH buffers, deformers, sizing agents such as styrene alkylketene dimer (AKD), alkenylsuccinic anhydride (ASA), styrene-maleic anhydride (SMA), styrene acrylate (SA), and alkyl-substituted urethane copolymers, rheological controllers such as thickeners, OBAs, and color dyes. The following example formulations of surface treatment solutions (104, 208) make reference to Table 1 and FIG. 3. FIG. 3 is a bar chart depicting the black color optical density (KoD) of the example formulations of surface treatment solutions of Table 1, according to one example of the principles described herein. Surface treatment solutions 1 through 4 contain only water soluble multi valent salts, and act as as controls in the remaining surface treatment solutions. Surface treatment solutions 5 through 19 contain water soluble salts and water dispersible salts, and surface treatment solutions 14 through 19 contain an organosilane and binders.

In a first example of a formulation of a surface treatment solution (104, 208), the surface treatment solution comprises approximately 1.00 wt % of a water soluble, multi-valent, organic acid salt such as, for example, calcium acetate hydrate (Ca(C₂H₃O₂)₂). The water soluble, multi-valent, organic acid salt is used within the surface treatment solution (104, 208) of this example and examples to follow as a crashing agent for pigment-based ink such as, for example, inkjet inks. The water soluble, multi-valent, organic acid salt also provides for better printability including a higher KoD. This formulation resulted in a print medium (102, 202) with a black color optical density (KoD) of 1.19 and a pH of 7.40. In a second example of a formulation of a surface treatment solution (104, 208), the surface treatment solution comprises approximately 0.90 wt % of a water soluble, multi-valent, organic acid salt such as, for example, calcium acetate hydrate (Ca(C₂H₃O₂)₂). This formulation resulted in a print medium (102, 202) with a (KoD) of 1.16 and a pH of 7.33.

In a third example of a formulation of a surface treatment solution (104, 208), the surface treatment solution comprises approximately 0.75 wt % of a water soluble, multi-valent, organic acid salt such as, for example, calcium acetate hydrate (Ca(C₂H₃O₂)₂). This formulation resulted in a print medium (102, 202) with a KoD of 1.13 and a pH of 6.68. In a fourth example of a formulation of a surface treatment solution (104, 208), the surface treatment solution comprises approximately 0.50 wt % of a water soluble, multi-valent, organic acid salt such as, for example, calcium acetate hydrate (Ca(C₂H₃O₂)₂). This formulation resulted in a print medium (102, 202) with a KoD of 1.04 and a pH of 7.10.

In a fifth example of a formulation of a surface treatment solution (104, 208), the surface treatment solution comprises approximately 0.90 wt % of a water soluble, multi-valent, organic acid salt such as, for example, calcium acetate hydrate (Ca(C₂H₃O₂)₂). This fifth example further comprises approximately 0.10 wt % of a water dispersible, multi-valent, organic acid salt such as, for example, calcium citrate tetrahydrate (Ca₃(C₆H_{S}O₇)₂.4H₂O). The water dispersible, multi-valent, organic acid salt is used within the surface treatment solution (104, 208) of this example and examples to follow as fixers to bond the ink colorant particles on the outermost surface of the media while reducing or eliminating of potential corrosion to print media production machines and printing devices. This fifth formulation resulted in a print medium (102, 202) with a KoD of 1.20 and a pH of 7.50.

In a sixth example of a formulation of a surface treatment solution (104, 208), the surface treatment solution comprises approximately 0.75 wt % of a water soluble, multi-valent, organic acid salt such as, for example, calcium acetate hydrate (Ca(C₂H₃O₂)₂), and approximately 0.25 wt % of a water dispersible, multi-valent, organic acid salt such as, for example, calcium citrate tetrahydrate (Ca₃(C₆H_{S}O₇)₂.4H₂O). This formulation resulted in a print medium (102, 202) with a KoD of 1.33 and a pH of 7.51.

In a seventh example of a formulation of a surface treatment solution (104, 208), the surface treatment solution comprises approximately 0.50 wt % of a water soluble, multi-valent, organic acid salt such as, for example, calcium acetate hydrate (Ca(C₂H₃O₂)₂), and approximately 0.50 wt % of a water dispersible, multi-valent, organic acid salt such as, for example, calcium citrate tetrahydrate (Ca₃(C₆H₅O₇)₂.4H₂O). This formulation resulted in a print medium (102, 202) with a KoD of 1.07 and a pH of 7.49.

In an eighth example of a formulation of a surface treatment solution (104, 208), the surface treatment solution comprises approximately 0.90 wt % of a water soluble, multi-valent, organic acid salt such as, for example, calcium acetate hydrate (Ca(C₂H₃O₂)₂), and approximately 0.10 wt % of a water dispersible, multi-valent, organic acid salt such as, for example, calcium citrate tetrahydrate (Ca₃(C₆H_{S}O₇)₂.4H₂O). This eighth example further comprises approximately 3.0 wt % starch ((C₆H₁₀O₅)ₙ). The starch is used within the surface treatment solution (104, 208) of this example and examples to follow as a binder to provide adhesion between dispersible salt particles and fillers, and between the print medium (102, 202) and the dispersible salt and fillers. This eighth formulation resulted in a print medium (102, 202) with a KoD of 1.21 and a pH of 7.51.

In a ninth example of a formulation of a surface treatment solution (104, 208), the surface treatment solution comprises approximately 0.75 wt % of a water soluble, multi-valent, organic acid salt such as, for example, calcium acetate hydrate (Ca(C₂H₃O₂)₂), approximately 0.25 wt % of a water dispersible, multi-valent, organic acid salt such as, for example, calcium citrate tetrahydrate (Ca₃(C₆H_{S}O₇)₂.4H₂O), and approximately 3.0 wt % starch ((C₆H₁₀O₅)ₙ). This formulation resulted in a print medium (102, 202) with a KoD of 1.28 and a pH of 7.51.

In a tenth example of a formulation of a surface treatment solution (104, 208), the surface treatment solution comprises approximately 0.50 wt % of a water soluble, multi-valent, organic acid salt such as, for example, calcium acetate hydrate (Ca(C₂H₃O₂)₂), approximately 0.50 wt % of a water dispersible, multi-valent, organic acid salt such as, for example, calcium citrate tetrahydrate (Ca₃(C₆H_{S}O₇)₂.4H₂O), and approximately 3.0 wt % starch ((C₆H₁₀O₅)ₙ). This formulation resulted in a print medium (102, 202) with a KoD of 1.07 and a pH of 7.48.

In an eleventh example of a formulation of a surface treatment solution (104, 208), the surface treatment solution comprises approximately 0.90 wt % of a water soluble, multi-valent, organic acid salt such as, for example, calcium acetate hydrate (Ca(C₂H₃O₂)₂), approximately 0.10 wt % of a water dispersible, multi-valent, organic acid salt such as, for example, calcium citrate tetrahydrate (Ca₃(C₆H_{S}O₇)₂.4H₂O), and approximately 3.0 wt % starch ((C₆H₁₀O₅)ₙ). This eleventh example further comprises approximately 3.0 wt % of a pigment such as ground calcium carbonate (GCC) (CaCO₃). The pigment is used within the surface treatment solution (104, 208) of this example and examples to follow to maintain a specific color of the print medium. This eleventh formulation resulted in a print medium (102, 202) with a KoD of 1.21 and a pH of 7.09.

In a twelfth example of a formulation of a surface treatment solution (104, 208), the surface treatment solution comprises approximately 0.75 wt % of a water soluble, multi-valent, organic acid salt such as, for example, calcium acetate hydrate (Ca(C₂H₃O₂)₂), approximately 0.25 wt % of a water dispersible, multi-valent, organic acid salt such as, for example, calcium citrate tetrahydrate (Ca₃(C₆H_{S}O₇)₂.4H₂O), and approximately 3.0 wt % starch ((C₆H₁₀O₅)ₙ). This twelfth example further comprises approximately 3.0 wt % of a pigment such as, for example, ground calcium carbonate (GCC) (CaCO₃). This formulation resulted in a print medium (102, 202) with a KoD of 1.26 and a pH of 6.82.

In a thirteenth example of a formulation of a surface treatment solution (104, 208), the surface treatment solution comprises approximately 0.50 wt % of a water soluble, multi-valent, organic acid salt such as, for example, calcium acetate hydrate (Ca(C₂H₃O₂)₂), approximately 0.50 wt % of a water dispersible, multi-valent, organic acid salt such as, for example, calcium citrate tetrahydrate (Ca₃(C₆H_{S}O₇)₂.4H₂O), approximately 3.0 wt % starch ((C₆H₁₀O₅)ₙ), and approximately 3.0 wt % of a pigment such as, for example, ground calcium carbonate (GCC) (CaCO₃). This formulation resulted in a print medium (102, 202) with a KoD of 1.07 and a pH of 7.33

In a fourteenth example of a formulation of a surface treatment solution (104, 208), the surface treatment solution comprises approximately 0.90 wt % of a water soluble, multi-valent, organic acid salt such as, for example, calcium acetate hydrate (Ca(C₂H₃O₂)₂), and approximately 0.10 wt % of a water dispersible, multi-valent, organic acid salt such as, for example, calcium citrate tetrahydrate (Ca₃(C₆H_{S}O₇)₂.4H₂O). This fourteenth example further comprises approximately 3.0 wt % of a polyvinyl alcohol ((C₂H₄O)ₓ). The polyvinyl alcohol is used within the surface treatment solution (104, 208) of this example and examples to follow as a binder to provide adhesion between dispersible salt particles and fillers, and between the print medium (102, 202) and the dispersible salt and fillers. This fourteenth example further comprises approximately 0.15 wt % of an organosilane such as, for example, gamma-aminopropyltriethoxysilane (C₉H₂₃NO₃Si). The organosilane is used within the surface treatment solution (104, 208) of this example and examples to follow to modify the surface properties of the dispersible salt particles to make the dispersible salt particles more readily react with both the print medium (102, 202) and ink colorant particles. This fourteenth formulation resulted in a print medium (102, 202) with a KoD of 1.41 and a pH of 7.12.

In a fifteenth example of a formulation of a surface treatment solution (104, 208), the surface treatment solution comprises approximately 0.75 wt % of a water soluble, multi-valent, organic acid salt such as, for example, calcium acetate hydrate (Ca(C₂H₃O₂)₂), approximately 0.25 wt % of a water dispersible, multi-valent, organic acid salt such as, for example, calcium citrate tetrahydrate (Ca₃(C₆H₅O₇)₂.4H₂O), approximately 3.0 wt % of a polyvinyl alcohol ((C₂H₄O)ₓ), and approximately 0.15 wt % of an organosilane such as, for example, gamma-aminopropyltriethoxysilane (C₉H₂₃NO₃Si). This formulation resulted in a print medium (102, 202) with a KoD of 1.34 and a pH of 7.31.

In a sixteenth example of a formulation of a surface treatment solution (104, 208), the surface treatment solution comprises approximately 0.50 wt % of a water soluble, multi-valent, organic acid salt such as, for example, calcium acetate hydrate (Ca(C₂H₃O₂)₂), approximately 0.50 wt % of a water dispersible, multi-valent, organic acid salt such as, for example, calcium citrate tetrahydrate (Ca₃(C₆H_{S}O₇)₂.4H₂O), approximately 3.0 wt % of a polyvinyl alcohol ((C₂H₄O)ₓ), and approximately 0.15 wt % of an organosilane such as, for example, gamma-aminopropyltriethoxysilane (C₉H₂₃NO₃Si). This formulation resulted in a print medium (102, 202) with a KoD of 1.27 and a pH of 7.03.

In a seventeenth example of a formulation of a surface treatment solution (104, 208), the surface treatment solution comprises approximately 0.90 wt % of a water soluble, multi-valent, organic acid salt such as, for example, calcium acetate hydrate (Ca(C₂H₃O₂)₂), approximately 0.10 wt % of a water dispersible, multi-valent, organic acid salt such as, for example, calcium citrate tetrahydrate (Ca₃(C₆H_{S}O₇)₂.4H₂O), approximately 3.0 wt % of a pigment such as ground calcium carbonate (GCC) (CaCO₃), approximately 3.0 wt % of a polyvinyl alcohol ((C₂H₄O)ₓ), and approximately 0.15 wt % of an organosilane such as, for example, gamma-aminopropyltriethoxysilane (C₉H₂₃NO₃Si). This seventeenth example further comprises approximately 0.10 wt % of a dispersant such as, for example, a sodium salt of a polyacrylic acid. The dispersant is used within the surface treatment solution (104, 208) of this example and examples to follow to maintain dispersed particles within the surface treatment such as the water dispersible, multi-valent, organic acid salt in suspension. This seventeenth formulation resulted in a print medium (102, 202) with a KoD of 1.27 and a pH of 7.03.

In an eighteenth example of a formulation of a surface treatment solution (104, 208), the surface treatment solution comprises approximately 0.75 wt % of a water soluble, multi-valent, organic acid salt such as, for example, calcium acetate hydrate (Ca(C₂H₃O₂)₂), approximately 0.25 wt % of a water dispersible, multi-valent, organic acid salt such as, for example, calcium citrate tetrahydrate (Ca₃(C₆H₅O₇)₂.4H₂O), approximately 3.0 wt % of a pigment such as ground calcium carbonate (GCC) (CaCO₃), approximately 3.0 wt % of a polyvinyl alcohol ((C₂H₄O)ₓ), approximately 0.10 wt % of a dispersant such as, for example, a sodium salt of a polyacrylic acid, and approximately 0.15 wt % of an organosilane such as, for example, gamma-aminopropyltriethoxysilane (C₉H₂₃NO₃Si). This formulation resulted in a print medium (102, 202) with a KoD of 1.36 and a pH of 6.93.

In a nineteenth example of a formulation of a surface treatment solution (104, 208), the surface treatment solution comprises approximately 0.50 wt % of a water soluble, multi-valent, organic acid salt such as, for example, calcium acetate hydrate (Ca(C₂H₃O₂)₂), approximately 0.50 wt % of a water dispersible, multi-valent, organic acid salt such as, for example, calcium citrate tetrahydrate (Ca₃(C₆H_{S}O₇)₂.4H₂O), approximately 3.0 wt % of a pigment such as ground calcium carbonate (GCC) (CaCO₃), approximately 3.0 wt % of a polyvinyl alcohol ((C₂H₄O)ₓ), approximately 0.10 wt % of a dispersant such as, for example, a sodium salt of a polyacrylic acid, and approximately 0.15 wt % of an organosilane such as, for example, gamma-aminopropyltriethoxysilane (C₉H₂₃NO₃Si). This formulation resulted in a print medium (102, 202) with a KoD of 1.29 and a pH of 6.85.

TABLE 1
Measure of black color optical density (KoD) and pH at different wt % of water soluble
salts, water dispersible salts, binders, pigments, dispersants, and organosilanes.

| | Water | Water | | | | | | | |
|---|---|---|---|---|---|---|---|---|---|
| | Soluble | Dispersible | | Pigments | | Dispersant | Organosilane | | |
| | Salt | Salt | | ground calcium | Binder | sodium | gamma- | KoD (Black | |
| | calcium acetate | calcium citrate | Binder | carbonate | polyvinyl | salt of a | aminopropyl- | Color | |
| Solu- | hydrate | tetrahydrate | starch | (GCC) | alcohol | polyacrylic | triethoxysilane | Optical | |
| tions | (Ca(C₂H₃O₂)₂) | (Ca₃(C₆H₅O₇)₂ [symbol] 4 | ((C₆H₁₀O₅)n) * | (CaCO₃) † | ((C₂H₄O)ₓ) ‡ | acid § | (C₉H₂₃NO₃Si) ¶ | Density) | pH |
| 1 | 1.00% | | | | | | | 1.19 | 7.40 |
| 2 | 0.90% | | | | | | | 1.16 | 7.33 |
| 3 | 0.75% | | | | | | | 1.13 | 6.68 |
| 4 | 0.50% | | | | | | | 1.04 | 7.10 |
| 5 | 0.90% | 0.10% | | | | | | 1.20 | 7.50 |
| 6 | 0.75% | 0.25% | | | | | | 1.33 | 7.51 |
| 7 | 0.50% | 0.50% | | | | | | 1.07 | 7.49 |
| 8 | 0.90% | 0.10% | 3% | | | | | 1.21 | 7.51 |
| 9 | 0.75% | 0.25% | 3% | | | | | 1.28 | 7.51 |
| 10 | 0.50% | 0.50% | 3% | | | | | 1.07 | 7.48 |
| 11 | 0.90% | 0.10% | 3% | 3% | | | | 1.21 | 7.09 |
| 12 | 0.75% | 0.25% | 3% | 3% | | | | 1.26 | 6.82 |
| 13 | 0.50% | 0.50% | 3% | 3% | | | | 1.07 | 7.33 |
| 14 | 0.90% | 0.10% | | | 3% | | 0.15% | 1.41 | 7.12 |
| 15 | 0.75% | 0.25% | | | 3% | | 0.15% | 1.34 | 7.31 |
| 16 | 0.50% | 0.50% | | | 3% | | 0.15% | 1.27 | 7.03 |
| 17 | 0.90% | 0.10% | | 3% | 3% | 0.10% | 0.15% | 1.35 | 6.48 |
| 18 | 0.75% | 0.25% | | 3% | 3% | 0.10% | 0.15% | 1.36 | 6.93 |
| 19 | 0.50% | 0.50% | | 3% | 3% | 0.10% | 0.15% | 1.29 | 6.85 |

* In one example, starch (2-hydroxyethyl starch ether) (a binder) is produced by Penford Products Co. ® under the tradename Penford ® Gum 280.
† In one example, ground calcium carbonate (GCC) (CaCO₃) is produced by Omya Inc. ™ under the tradename HYDROCARB ® 60.
‡ In one example, polyvinyl alcohol ((C₂H₄O)ₓ) is produced by Kuraray Co., Ltd. ™ under the tradename MOWIOL ® 40-88.
§ In one example, sodium salt of a polyacrylic acid (a dispersant) is produced by Rohm and Haas Company ® under the tradename ACUMER ® 9300.
¶ In one example, gamma-aminopropyltriethoxysilane (C₉H₂₃NO₃Si) is produced by OSi Specialties, Inc. ™ under the tradename SILQUEST ® A1100 ® silane has a structural formula of H₂NCH₂CH₂CH₂Si(OCH₂CH₃)₃. [symbol]
indicates data missing or illegible when filed

The specification and figures describe a surface treatment solution, a print medium, and methods of forming a surface treated medium. The surface treatment solution comprises a number of water soluble, multi-valent salts, a number of water dispersible, multi-valent salts, a binder that binds the water dispersible, multi-valent salts to a medium and to the elements within the surface treatment solution, and an organosilane. This surface treatment solution and associated print medium may have a number of advantages, including improved optical density when utilized with pigment-based inks, elimination of print medium degradation, and a more consistent, economical, and precise printing surface. Further, this surface treatment solution and associated print medium may cause the medium to improve in the areas of abrasiveness, creasibility, finish, printability, smoothness, water resistance, and surface bond strength, while decreasing surface porosity and fuzzing.

The preceding description has been presented to illustrate and describe examples of the principles described. This description is not intended to be exhaustive or to limit these principles to any precise form disclosed. Many modifications and variations are possible in light of the above teaching.

What is claimed is:

1. A method of forming a surface treated medium comprising:
forming a surface treatment solution comprising:
a number of water soluble, multi-valent salts;
a number of water dispersible, multi-valent salts;
a binder that binds the water dispersible, multi-valent salts to a medium and to the elements within the surface treatment solution; and
an organosilane; and
applying the surface treatment solution to a medium.

2. The method of claim 1, in which the water soluble, multi-valent, salts are water soluble, multi-valent, organic acid salts.

3. The method of claim 1, in which the water dispersible, multi-valent, salts are water dispersible, multi-valent, organic acid salts.

4. The method of claim 1, in which forming a surface treatment solution further comprises combining the water soluble, multi-valent salts and water dispersible, multi-valent salts at a ratio of between approximately 9:1 and 1:1.

5. The method claim 1, in which in which forming a surface treatment solution further comprises combining the water soluble, multi-valent salts and water dispersible, multi-valent salts at a ratio of between approximately 4:1 and 1:1.

6. The method claim 1, in which the surface treatment solution further comprises a treating agent, in which the treating agent comprises an organosilane, mono amino silanes, diamino silanes, triamino silanes, or combinations thereof.

7. The method claim 1, in which forming a surface treatment solution further comprises combining the water dispersable, multi-valent salts and organosilanes at a ratio of between approximately 1:2 and 10:1.

8. The method claim 1, in which applying the surface treatment solution to a medium comprises applying the surface treatment solution to a medium at a coatweight of between approximately 0.2 and 6 gsm.

9. The method claim 1, in which applying the surface treatment solution to a medium comprises applying the surface treatment via a puddle size press, applying the surface treatment via a metered size press, spray coating, gravure coating, reverse roll coating, gap coating, slot die coating, immersion coating, curtain coating, blade coating, rod coating, air knife coating, or combinations thereof.

10. The method of claim 1, in which applying the surface treatment solution to a medium comprises applying the surface treatment solution to a plurality of surfaces of the medium.

11. A surface treatment solution comprising:
a number of water soluble, multi-valent, organic acid salts;
a number of water dispersible, multi-valent, organic acid salts;
a binder that binds the water dispersible, multi-valent, organic acid salts to a medium and to the elements within the surface treatment solution; and
an organosilane.

12. The surface treatment solution of claim 11, in which the ratio of water soluble, multi-valent, organic acid salts to water dispersible, multi-valent, organic acid salts is between approximately 4:1 and 1:1.

13. The surface treatment solution of claim 11, in which the ratio of water soluble, multi-valent, organic acid salts to water dispersible, multi-valent, organic acid salts is between approximately 9:1 and 2:1.

14. The surface treatment solution of claim 11, in which the water soluble, multi-valent, organic acid salts comprise calcium acetate, calcium acetate hydrate, calcium acetate monohydrate, magnesium acetate, magnesium acetate tetrahydrate, calcium propionate, calcium propionate hydrate, calcium gluconate monohydrate, calcium formate, or combinations thereof.

15. The surface treatment solution of claim 11, in which the water dispersible, multi-valent, organic acid salts comprise calcium citrate, calcium citrate tetrahydrate, calcium oleate, calcium oxalate, or combinations thereof.

16. The surface treatment solution of claim 11, in which the binder comprises a starch, oxidized starch, cationic starch, ethylated starch, polyvinyl alcohol, polyvinyl acetate, latex, or combinations thereof.

17. The surface treatment solution of claim 11, further comprising a number of pigments.

18. The surface treatment solution of claim 17, in which the pigments comprise ground calcium carbonate, precipitated calcium carbonate, titanium dioxide, clays, talc, carbonates, silica, or combinations thereof.

19. A print medium comprising:
a surface treatment solution disposed on the print medium, the surface treatment solution comprising:
a number of water soluble, multi-valent, organic acid salts;
a number of water dispersible, multi-valent, organic acid salts;
a binder that binds the water dispersible, multi-valent, organic acid salts to a medium and to the elements within the surface treatment solution; and
an organosilane.

20. The print medium of claim 19, in which the surface treatment solution is applied to the print medium via a puddle size press, a metered size press, spray coating, gravure coating, reverse roll coating, gap coating, slot die coating, immersion coating, curtain coating, blade coating, rod coating, air knife coating, or combinations thereof.
